(19) United States
(12) Patent Application Publication
(10) Pub. No.: US 2024/0194926 A1
(43) Pub. Date: Jun. 13, 2024

(54) CONTAINMENT APPARATUS FOR BATTERY TRAY RACK

(71) Applicant: CHROMA ATE INC., Taoyuan City (TW)

(72) Inventors: Ying-Cheng Chen, Taoyuan City (TW); Wen-Chuan Chang, Taoyuan City (TW); Ying-Chi Chen, Taoyuan City (TW); Chuan-Tse Lin, Taoyuan City (TW)

(73) Assignee: CHROMA ATE INC., Taoyuan City (TW)

(21) Appl. No.: 18/516,682

(22) Filed: Nov. 21, 2023

(30) Foreign Application Priority Data
Dec. 13, 2022 (TW) 111147726

(51) Int. Cl. H01M 10/04

(52) U.S. Cl. CPC H01M 10/0404

(57) ABSTRACT

A containment apparatus for battery tray rack includes a pressing module, a securing module, and a controller. In response to that the containment apparatus is to form the containment on the battery tray rack, the controller controls the pressing module to apply a compressive force, so that the battery tray rack withstands a clamping pressure, and the controller controls the securing module to lock the battery tray rack to maintain the clamping pressure. In response to that the containment apparatus is to release the containment from the battery tray rack, the controller controls the pressing module to apply the compressive force, and the controller controls the securing module to unlock the battery tray rack, and then the controller controls the pressing module to cancel the compressive force.

### CROSS-REFERENCE TO RELATED APPLICATION

This non-provisional application claims priority under 35 U.S.C. § 119(a) to Patent Application No. 111147726 filed in Taiwan, R.O.C. on Dec. 13, 2022, the entire contents of which are hereby incorporated by reference.

### BACKGROUND

### Technical Field

The instant disclosure is related to an apparatus adopted in the production line of battery formation industries, especially to a containment apparatus for battery tray rack which can form a containment on the battery tray rack or release the containment on the battery tray rack.

### Related Art

In the battery manufacturing industry, as known to the inventor, an apparatus is provided for forming a containment or releasing the containment in the formation process in the production line of battery formation industries. In general, the apparatus includes a compressive component, and the compressive component takes a single screw as a force-applying member, so that the apparatus applies a containment force on the battery tray rack through the single screw. Therefore, several soft-pack lithium batteries can be clamped so that the shape of the batteries can be retained. Likewise, when the foregoing procedures are applied reversely, the compressive force applied on the batteries for retaining the shape of the batteries can be released, so that the containment applied on the battery tray rack is canceled. For the apparatus known to the inventor, China patent publication No. CN 111326781A “Automatic switching, pressurizing and clamping mechanism for soft package battery tray and switching and clamping method” and China patent publication No. CN 111261920A “Restraining and unrestraining apparatus” can be referred.

As mentioned above, for a battery tray rack known to the inventor, in response to that the containment apparatus applies the compressive force to form a containment on the battery tray rack, the containment apparatus pushes the battery partition plates on the battery tray rack merely through the screw. Therefore, a containment is formed on the soft-pack lithium batteries to prevent over-expansion during the formation process.

However, as known to the inventor, the battery tray rack is devoid of cushioning mechanism for battery inflations, and thus the force generated by the battery inflation is totally withstand by the screw and the battery partition plates. As a result, when the structural strength of the screw or the battery partition plates are not sufficient, damage of the battery tray rack may occur easily. On the other hand, in order to prevent such condition, the screw and the battery partition plates are expected to have sufficient structural strengths, leading these members to have larger sizes and thus causing the increase of the costs.

Furthermore, after prolonged use, because the screw and the battery partition plates have to repeatedly suffer large stresses (especially the stress concentrated on the screw during the compressive force-applying process is very apparent), and also because of the material fatigue, the service lives of the screw and the battery partition plates are greatly affected. In view of this, how to provide a new apparatus for forming/releasing the containment is to be addressed, in which the apparatus has further optimized mechanical design so to be form/release the containment on the battery tray rack more stably.

### SUMMARY

One of objects of one or some embodiments of the instant disclosure is to provide a containment apparatus for battery tray rack. During forming the containment on the battery tray rack, the force can be applied uniformly and stably, and during releasing the containment on the battery tray rack, the compressive force applied on the battery tray rack can be released smoothly. Moreover, the overall operation of the containment apparatus is reliable and stable, thus enhancing the durability and cost-effectiveness of the containment apparatus.

To achieve the object, one or some embodiments of the instant disclosure provides a containment apparatus for battery tray rack. The containment apparatus is adapted to apply a compressive force to a battery tray rack and to form a containment on the battery tray rack or is to release the containment on the battery tray rack to cancel the compressive force. The battery tray rack comprises a force-bearing plate and at least one clamping bolt. The containment apparatus comprises a frame, a pressing module, at least one securing module, and a controller.

The frame of the containment apparatus comprises a base, and the pressing module of the containment apparatus corresponds to the force-bearing plate of the battery tray rack. The pressing module comprises a compressive force generator and a pressing head. The pressing head is connected to the compressive force generator, the compressive force generator is arranged on the frame, and the compressive force generator is adapted to drive the pressing head to move toward or away from the battery tray rack. Moreover, the at least one securing module of the containment apparatus corresponds to the at least one clamping bolt of the battery tray rack. The at least one securing module comprises a slidable stage and a locking device. The locking device is arranged on the slidable stage, and the slidable stage is slidably arranged on the base and coupled to the pressing head. Moreover, the controller of the containment apparatus is electrically connected to the pressing module and the securing module, and the controller of the containment apparatus is adapted to control the operations of the pressing module and the securing module.

Specifically, in one or some embodiments, the controller drives the compressive force generator to move the at least one securing module toward the battery tray rack through the pressing head and to compress the battery tray rack, or the controller controls the locking device to lock the battery tray rack to form a containment on the battery tray rack or to unlock the battery tray rack to release the containment. Therefore, in response to that the containment apparatus is to form the containment on the battery tray rack, the controller controls the pressing module to apply the compressive force to the force-bearing plate, so that the battery tray rack withstands a clamping pressure, and the controller controls the at least one securing module to lock the at least one clamping bolt to maintain the clamping pressure. Moreover, in response to that the controller controls the at least one securing module to unlock the at least one clamping bolt, the controller controls the pressing module to apply the compressive force to the force-bearing plate, and in response to that the controller controls the at least one securing module to unlock the at least one clamping bolt, the controller controls the pressing module to cancel the compressive force applied to the force-bearing plate.

Therefore, as compared with a containment apparatus known to the inventor, according to the containment apparatus for battery tray rack in one or some embodiments, the pressing module applies the compressive force to the battery tray rack, and then the battery tray rack is locked to form the containment on the battery tray rack. Likewise, as compared with the containment apparatus known to the inventor, according to the containment apparatus for battery tray rack in one or some embodiments, the pressing module applies the compressive force to the battery tray rack, and then the battery tray rack is unlocked to release the containment on the battery tray rack. Accordingly, the stresses withstood by the clamping bolt and the securing module can be greatly reduced, and the stress can be prevented from being concentrated at certain portions of the apparatus. Furthermore, the operation of the containment apparatus is reliable and stable, so that the service life of the battery tray rack can be greatly increased.

### BRIEF DESCRIPTION OF THE DRAWINGS

The disclosure will become more fully understood from the detailed description given herein below for illustration only, and thus not limitative of the disclosure, wherein:

FIG. 1A illustrates a perspective view of a containment apparatus according to an exemplary embodiment of the instant disclosure, wherein the containment apparatus is provided with a conveyor;

FIG. 1B illustrates a front view of the containment apparatus according to an exemplary embodiment of the instant disclosure, wherein the containment apparatus is not provided with a conveyor;

FIG. 2 illustrates a perspective view of the containment apparatus according to an exemplary embodiment of the instant disclosure, wherein the containment apparatus is not provided with a battery tray rack;

FIG. 3 illustrates a system architecture diagram of the containment apparatus according to an exemplary embodiment of the instant disclosure;

FIG. 4A illustrates a perspective view of a pressing module and a securing module of the containment apparatus according to an exemplary embodiment of the instant disclosure;

FIG. 4B illustrates a side view of the pressing module and the securing module of the containment apparatus according to an exemplary embodiment of the instant disclosure;

FIG. 5 illustrates a cross-sectional view of coupling structures of the pressing module and the securing module of the containment apparatus according to an exemplary embodiment of the instant disclosure;

FIG. 6A illustrates a cross-sectional view of a locking device of the containment apparatus according to an exemplary embodiment of the instant disclosure; and

FIG. 6B illustrates an exploded view of the locking device of the containment apparatus according to an exemplary embodiment of the instant disclosure, wherein the electric motor is not shown.

### DETAILED DESCRIPTION

Prior to the description of a containment apparatus for battery tray rack according to one or some embodiments is provided, it is understood that in the following descriptions, similar elements are denoted by identical reference numbers. Moreover, the figures in the instant disclosure are provided merely for illustrative purposes and may not necessarily be drawn to scale, and not all the details of the instant disclosure may be shown in the figures.

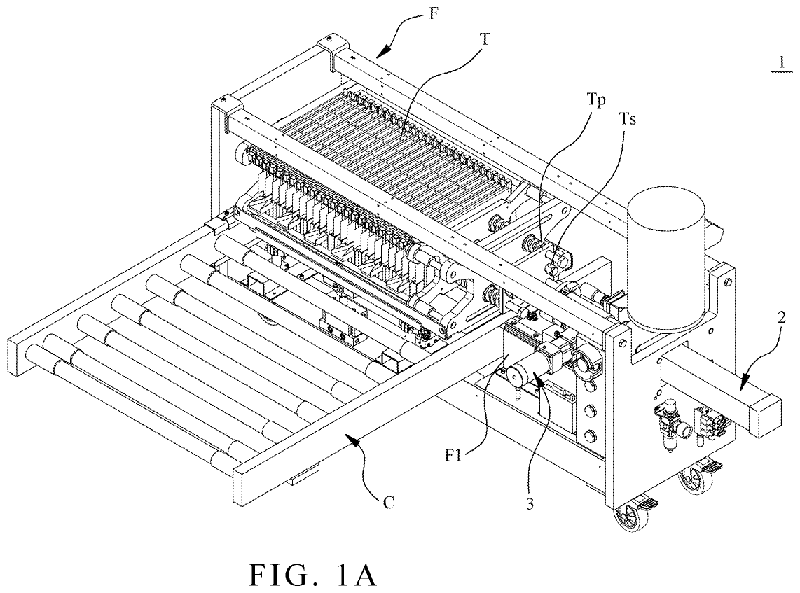

Please refer to FIG. 1A. FIG. 1A illustrates a perspective view of a containment apparatus according to an exemplary embodiment of the instant disclosure, wherein the containment apparatus is provided with a conveyor. As shown, the containment apparatus 1 according to one or some embodiments of the instant disclosure is adapted to apply a compressive force to a battery tray rack T to form a containment on the battery tray rack T, and the containment is retained for fastening sot that the shape of the soft-pack lithium batteries in the battery tray rack T can be retained. Therefore, the soft-pack lithium batteries can be prevented from excessively expanded during the battery formation process. After the formation process is completed, the containment apparatus 1 according to one or some embodiments of the instant disclosure is also adapted to release the battery tray rack from the containment.

Specifically, in some embodiment, the battery tray rack T on which a containment is to be formed before the battery formation process or the battery tray rack T on which the containment is to be released after the battery formation process is conveyed to the containment apparatus 1 through the conveyor C. However, it should be noted that, although the conveyor C is configured at one side of the containment apparatus 1 in FIG. 1, i.e., in this embodiment, the entry and the exit are on one side, the instant disclosure is not limited thereto. In some embodiments, the battery tray rack T is conveyed to the containment apparatus 1 and conveyed out of the containment apparatus 1 from two sides of the containment apparatus 1 (which indicates that the entry and the exit are on two sides of the containment apparatus 1).

As shown in FIG. 1A, the battery tray rack T comprises a force-bearing plate Tp and two clamping bolts Ts. The force-bearing plate Tp is arranged on the right side of the battery tray rack T. The left side of the battery tray rack T abuts against the left bottom portion of the interior of the containment apparatus 1. Therefore, in response to that the force-bearing plate Tp is pushed by an external force, through several force-bearing springs, a compressive force is applied to the battery tray rack T along a direction from right to left, and the clamping bolts Ts are locked to retain the compressive force (the containment provided by the containment apparatus 1). Likewise, once the clamping bolts Ts are unlocked, the compressive force can be released, and the containment provided by the containment apparatus 1 can be released.

Moreover, the containment apparatus 1 comprises a pressing module 2 and a securing module 3. The pressing module 2 corresponds to the force-bearing plate Tp of the battery tray rack T and is adapted to apply a compressive force to the force-bearing plate Tp to form the containment. The securing module 3 corresponds to the clamping bolts Ts of the battery tray rack T and is adapted to lock the clamping bolts Ts to retain the compressive force or to unlock the clamping bolts to release the compressive force.

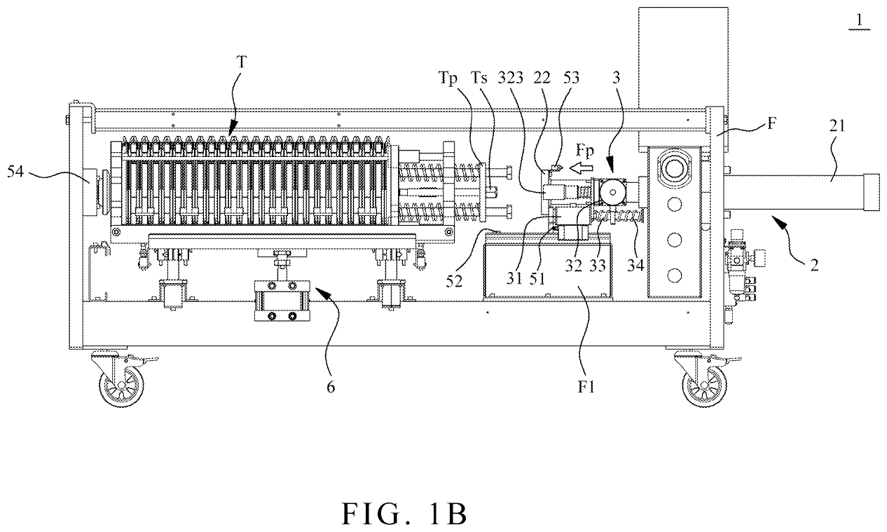

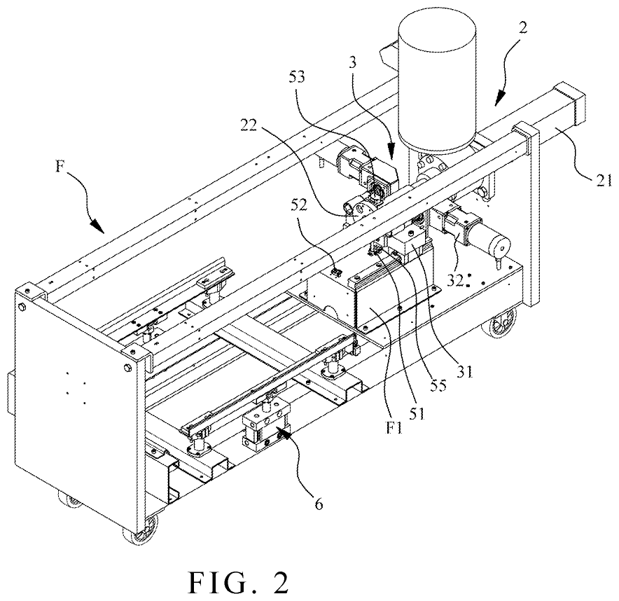

Please refer to FIG. 1A, FIG. 1B, FIG. 2, and FIG. 3. FIG. 1B illustrates a front view of the containment apparatus according to an exemplary embodiment of the instant disclosure, wherein the containment apparatus is not provided with a conveyor. FIG. 2 illustrates a perspective view of the containment apparatus according to an exemplary embodiment of the instant disclosure, wherein the containment apparatus is not provided with a battery tray rack. FIG. 3 illustrates a system architecture diagram of the containment apparatus according to an exemplary embodiment of the instant disclosure. As shown in the figures, according to one embodiment of the instant disclosure, the containment apparatus 1 further comprises a frame F and a controller 4. The pressing module 2 and the securing module 3 are arranged on the frame F, and one side of the frame F adjacent to the securing module 3 is provided with a base F1.

Moreover, the front side and the rear side of the frame F each are provided with a lifting module 6 adapted to lift the battery tray rack T to a preset height for forming the containment or releasing the containment. Therefore, during forming or releasing the containment, the battery tray rack T and the conveyor C can be separated from each other. The controller 4 is electrically connected to the lifting module 6, the pressing module 2, and the securing module 3, and the controller 4 is adapted to control the operations of these modules so as to form the containment or to release the containment on the battery tray rack T.

The controller 4 has a conventional structure and may include a processor, memory, storage media, communications devices, and input and output devices. For example, the controller 4 can be a standard microcontroller that includes a central processing unit (CPU), random access memory (RAM), read only memory (ROM) and input/output ports receiving input signals and sending output signals needed to control the system and to perform certain process steps as described herein. The functions described herein are generally programming instructions stored in memory and are performed by the logic of the CPU. Of course, the controller that performs the functions described herein could be a microprocessor using external memory or could comprise a combination of such a microprocessor or microcontroller combined with other integrated logic circuits. The controller 4 is generally incorporated into or works with a personal computer with a screen and input devices, such as keyboards, for inputting commands for process control and for monitoring the process control.

Specifically, in this embodiment, the pressing module 2 comprises a compressive force generator 21 and a pressing head 22. In this embodiment, a screw jack reducer driven by a motor is served as the compressive force generator 21, wherein the screw jack is configured horizontally, and the operating direction has been changed from vertical lifting to horizontal movement. Moreover, the compressive force generator 21 is arranged on the frame F to provide a compressive force up to 1500 kgf. The pressing head 22 is connected to an end portion of the screw of the screw jack. Therefore, the compressive force generator 21 is adapted to drive the pressing head 22 to move toward or away from the battery tray rack T. Other than the combination of the screw jack reducer and the motor, in some embodiments, hydraulic cylinders, electric cylinders, or other equivalent devices that can provide compressive force may also be served as the compressive force generator 21.

Moreover, the securing module 3 comprises a slidable stage 31 and a locking device 32. The locking device 32 is arranged on the slidable stage 31, the slidable stage 31 is slidably arranged on the base F1 through the rails and grooves, and the slidable stage 31 is also coupled to the pressing head 22. Therefore, the compressive force generator 21, the pressing head 22, the slidable stage 31, and the locking device 32 are coupled to each other, thus enabling the pressing module 2 to move together with the securing module 3.

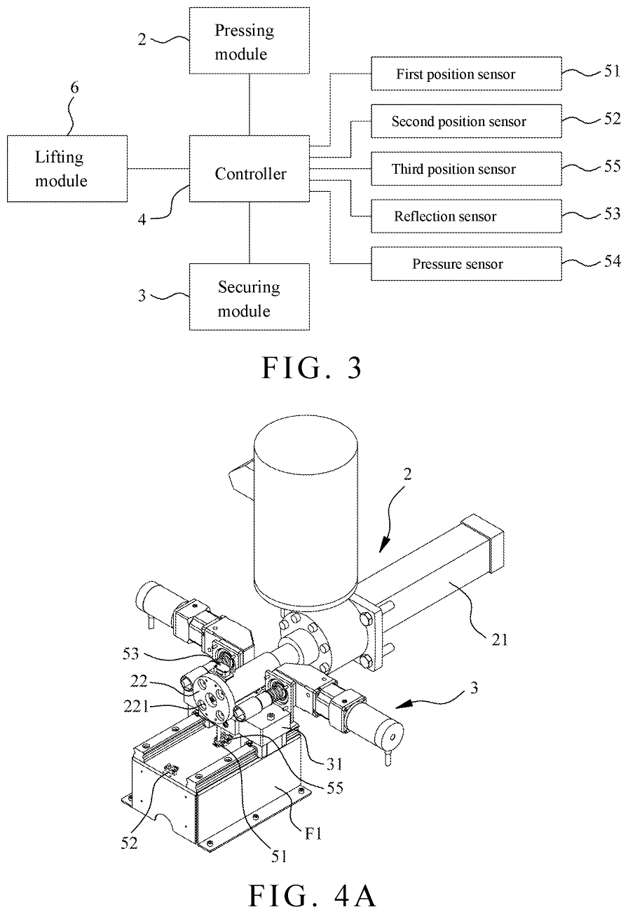

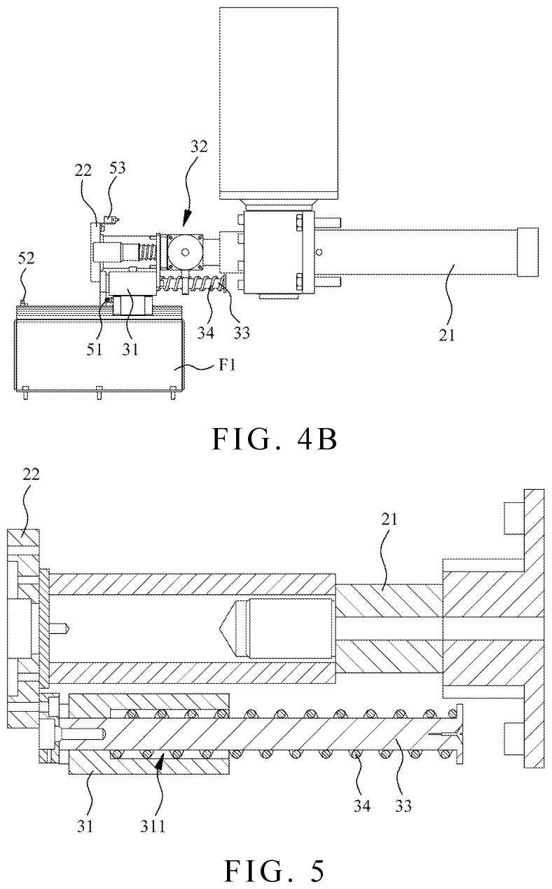

Please refer to FIG. 4A, FIG. 4B, and FIG. 5. FIG. 4A illustrates a perspective view of a pressing module and a securing module of the containment apparatus according to an exemplary embodiment of the instant disclosure. FIG. 4B illustrates a side view of the pressing module and the securing module of the containment apparatus according to an exemplary embodiment of the instant disclosure. FIG. 5 illustrates a cross-sectional view of coupling structures of the pressing module and the securing module of the containment apparatus according to an exemplary embodiment of the instant disclosure. As shown, in addition to the slidable stage 31 and the locking device 32, the securing module 3 further comprises a guiding post 33 and a compression spring 34, and the slidable stage 31 further has a through hole 311.

Moreover, the guiding post 33 passes through the through hole 311. One of two ends of the guiding post 33 is connected to the pressing head 22, so that the guiding post 33 can be driven by the pressing head 22. Furthermore, the compression spring 34 is fitted over the guiding post 33, and two ends of the compression spring 34 respectively abut against the through hole 311 and the other end of the guiding post 33. Therefore, in response to that the guiding post 33 is driven by the pressing head 22 to move toward the battery tray rack T (as shown in FIG. 1B), the compression spring 34 is compressed, and the resilient force of the compression spring 34 drives the slidable stage 31 to move toward the battery tray rack T as well.

Accordingly, the controller 4 just needs to drive the compressive force generator 21 to move the pressing head 22, then the pressing head 22 can move the slidable stage 31 toward the battery tray rack T through the guiding post 33 and the compression spring 34; the compression spring 34 can be further served as a cushioning member for absorbing the impact force. On the other hand, the controller 4 drives the compression force generator 21 to move the pressing head 22, then the pressing head 22 can move the slidable stage 31 away from the battery tray rack T, wherein the pressing head 22 directly 22 moves the slidable stage 31 and then drives the securing module 3 back to the original position.

Moreover, as shown in FIG. 1B, FIG. 3, FIG. 4A, and FIG. 4B, the containment apparatus 1 further comprises five sensors electrically connected to the controller 1, respectively a first position sensor 51, a second position sensor 52, a third position sensor 55, a reflection sensor 53, and a pressure sensor 54. Specifically, in this embodiment, the first position sensor 51, the second position sensor 52, and the third position sensor 55 may be photo interrupters, the reflection sensor 53 may be a proximity sensor, and the pressure sensor 54 may be a load cell.

Specifically, in this embodiment, the first position sensor 51 is arranged at one side of the base F1 adjacent to the compressive force generator 21, and the position of the first position sensor 51 corresponds to an initial position of a stroke of the pressing head 22. The second position sensor 52 is arranged at one side of the base F1 adjacent to the battery tray rack T, and the position of the second position sensor 52 corresponds to a maximum position of the stroke of the pressing head 22. In response to that the pressing head 22 exceeds the second position sensor 52 and the operation of the pressing head 22 still continues, the cylinder of the screw jack will be detached from the reducer. The third position sensor 55 is arranged on one side of the base F1, and the third position sensor 55 is much closer to the compressive force generator 21 as compared with the first position sensor 51 (the distance between the third position sensor 55 and the compressive force generator 21 is less than the distance between the first position sensor 51 and the compressive force generator 21), and the position of the third position sensor 55 corresponds to another maximum position of the stroke of the pressing head 22. In response to that the pressing head 22 exceeds the third position sensor 55 and the operation of the pressing head 22 still continues, the securing module 3 collides with the reducer. Accordingly, the second position sensor 52 and the third position sensor 55 are configured to control the maximum positions of the stroke of the pressing head 22. In response to that the second position sensor 52 or the third position sensor 55 detects that the pressing head 22, the controller 4 will immediately stop driving the compressive force generator 21 to prevent collision or detachment between the components.

The reflection sensor 53 is arranged on the pressing head 22, and the reflection sensor 53 is adapted to detect the distance between the pressing head 22 and the battery tray rack T (more specifically, in one embodiment, the distance between the pressing head 22 and the force-bearing plate Tp). The controller 4 can control the feeding speed according to the detection result of the reflection sensor 53, for example, in response to that the pressing head 22 moves toward the force-bearing plate Tp with a distance therebetween being less than a certain value, the controller 4 starts reducing the feeding speed of the pressing head 22. Moreover, the pressure sensor 54 is arranged on the frame F (more specifically, in one embodiment, the pressure sensor 54 is arranged on one side of the frame F away from the pressing module, so that the pressure sensor 54 is arranged between the frame F and the battery tray rack T), and the pressure sensor 54 is configured to detect a compressive force applied to the battery tray rack T by the compressive force generator 21. In response to that the compressive force measured by the pressure sensor 54 reaches a set value, the controller 4 stops the operation of the compressive force generator 21 and takes the current position of the pressing head 22 as the terminal position of the stroke of the pressing head 22. However, it is noted that, the terminal position of the stroke cannot exceed the maximum position of the stroke where the second position sensor 52 is located.

Further, as shown in FIG. 1B, FIG. 4A, and FIG. 4B, one or more magnets 221 may be provided on the pressing head 22. Therefore, in response to that the controller 4 controls the locking device 32 to unlock the battery tray rack T to release the containment, the controller 4 drives the compressive force generator 21 to move the pressing head 22 away from the battery tray rack T, and the magnet 221 will attract the force-bearing plate Tp thus stretching the battery tray rack. Therefore, the interval between the battery partition plates on the battery tray rack T can be increased. Accordingly, this configuration facilitates the replacement of the battery partition plates.

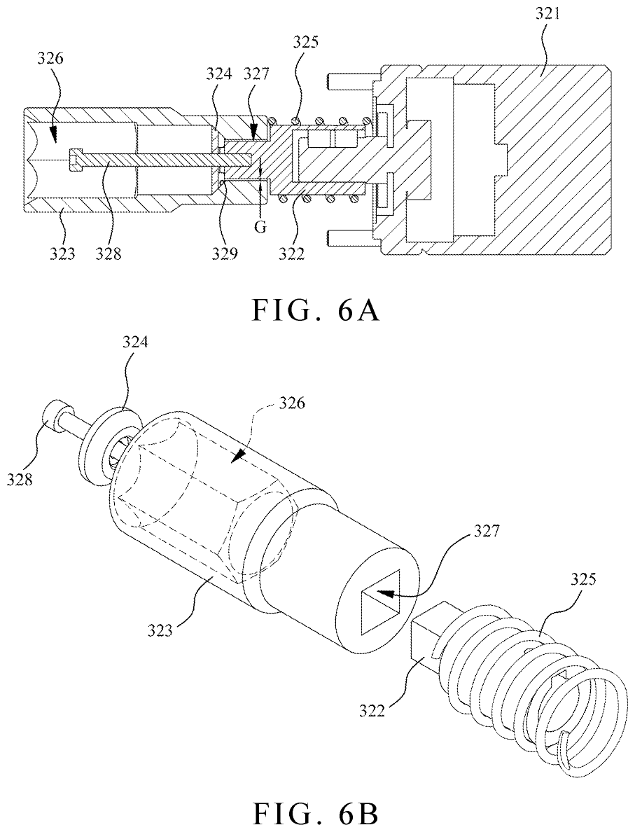

Last but not least, please refer to FIG. 1B, FIG. 6A, and FIG. 6B. FIG. 6A illustrates a cross-sectional view of a locking device of the containment apparatus according to an exemplary embodiment of the instant disclosure, and FIG. 6B illustrates an exploded view of the locking device of the containment apparatus according to an exemplary embodiment of the instant disclosure, wherein the electric motor is not shown. As shown, in one or some embodiments, the locking device 32 comprises an electric motor 321, a socket adapter 322, a socket 323, and a spring 325. Two end surfaces of the socket 323 have a bolt-fitting hole 326 and an adapter-fitting hole 327, respectively.

Specifically, in one or some embodiments, the bolt-fitting hole 326 is configured to be connected to the clamping bolt Ts of the battery tray rack T, and the adapter-fitting hole 327 is adapted to be fitted over the socket adapter 322. Furthermore, a radial tolerance G is between the adapter-fitting hole 327 and the socket adapter 322; that is, in this embodiment, the hole diameter of the adapter-fitting hole 327 is greater than the outer diameter of the socket adapter 433. Therefore, a movement tolerance of the socket 323 with respect to the socket adapter 322 can be provided, and the socket 323 can be slightly swung to accommodate the position of the clamping bolt Ts, so that the connection between the socket 323 and the clamping bolt Ts can be achieved more smoothly.

Moreover, the socket adapter 322 is connected to the electric motor 321, and the spring 325 is fitted over the socket adapter 322. One of two ends of the spring 325 abuts against the electric motor 321, and the other end of the spring abuts against the socket 323. Therefore, after the socket 323 is detached from the clamping bolt Ts, the spring 325 allows the socket 323 to move resiliently to be in a substantial horizontal state, thereby facilitating the socket 323 to be connected to the clamping bolt Ts of a next battery tray rack T.

The locking device 32 further comprises a cone-shaped washer 324 and a fixation screw 328, and the bolt-fitting hole 326 of the socket 323 further has a cone-shaped bottom surface 329. Specifically, in one or some embodiments, the cone-shaped washer 324 is accommodated in the bolt-fitting hole 326 and abuts against the cone-shaped bottom surface 329. The cone-shaped washer 324 and the cone-shaped bottom surface 329 are adapted to allow the socket 323 to swing corresponding to the position of the clamping bolt Ts, thereby facilitating the socket 323 to be connected to the clamping bolt Ts. Moreover, through configuring the locking device 32 to have different radial tolerances G between the adapter-fitting hole 327 and the socket adapter 322, the swingable extent of the socket 323 can be altered, thus increasing or decreasing the flexibility of the movement. Moreover, the fixation screw 328 passes through the bolt-fitting hole 326 and the cone-shaped washer 324 and is secured to the socket adapter 322.

Please refer to FIG. 1A and FIG. 1B. The operation for forming the containment according to this embodiment is described as below. In response to that the battery tray rack T to be treated with the battery formation process enters the containment apparatus 1 through the conveyor C, the controller 4 controls the lifting module 6 to lift the battery tray rack T, so that the pressing head 22 corresponds to the force-bearing plate Tp and the socket 323 corresponds to the clamping bolt Ts. Next, the controller 4 drives the compressive force generator 21 to move the pressing head 22 toward the battery tray rack T, and the securing module 3 is also fed simultaneously.

The detail operation according to one or some embodiments of the instant disclosure is further described as below. Firstly, the socket 323 is fitted over the clamping bolt Ts, and the compression spring 34 is compressed so as to apply a pre-load on the slidable stage 31, which allows the socket 323 to be closely fitted over the clamping bolt Ts. Then, the pressing head 22 abuts against the force-bearing plate Tp, and the compressive force generator continues feeding to push the force-bearing plate Tp and to apply a compressive force Fp to the force-bearing plate Tp, so that the battery tray rack T withstands a clamping pressure. In response to that the compressive force detected by the pressure sensor 54 reaches a set value, the controller 4 stops the operation of the compressive force generator 21 and takes the current position of the pressing head 22 as the terminal position of the stroke of the pressing head 22.

However, during the feeding of the pressing head 22, the force-bearing spring of the battery tray rack T withstands the compressive force Fp and is thus compressed, and the soft-pack lithium batteries withstands the clamping pressure to be fastened so that the shape of the soft-pack lithium batteries can be retained. Moreover, the controller 4 drives the electric motor 321 to lock the clamping bolt Ts at the same time so as to retain the clamping pressure, and the force-bearing spring is also maintained at the compressed state to form the containment on the battery tray rack T. In response to that the clamping bolt Ts is locked, the controller 4 drives the compressive force generator 21 to move the pressing head 22 and the securing module 3 away from the battery tray rack T, and the movement of the pressing head 22 is stopped in response to that the pressing head 22 reaches the position of the first position sensor 51.

The operation for releasing the containment according to this embodiment is similar to that for forming the containment. It is noted that, in response to the pressing head 22 abuts against the force-bearing plate Tp, the pressing module 2 firstly applies a force slightly greater than the compressive force on the force-bearing plate Tp, and the stress on the clamping bolt Ts can be removed. Next, the controller 4 drives the electric motor to release and unlock the clamping bolt Ts. At the same time, the controller 4 drives the compressive force generator 21 to move the pressing head 22 and the securing module 3 away from the battery tray rack T. The clamping pressure is gradually and slowly removed, and the force-bearing spring is recovered resiliently to release the containment, and the battery tray rack T is stretched through the magnet 221 on the pressing head 22. In response to that the stretching distance reaches the limit, the magnet 221 is automatically detached from the force-bearing plate Tp, and the pressing head 22 continues to retract until the pressing head 22 reaches the position of the first position sensor 51. Accordingly, the operation for releasing the containment can be achieved.

The above embodiments are merely examples for the purpose of illustration, and the scope claimed in the instant disclosure should be based on the claims and is not limited to the above embodiments.

What is claimed is:

1. A containment apparatus for battery tray rack, wherein the containment apparatus comprises:
a frame comprising a base;
a pressing module comprising a compressive force generator and a pressing head, wherein the pressing head is connected to the compressive force generator, the compressive force generator is arranged on the frame, and the compressive force generator is adapted to drive the pressing head to move toward or away from the battery tray rack;
at least one securing module comprising a slidable stage and a locking device, wherein the locking device is arranged on the slidable stage, and the slidable stage is slidably arranged on the base and coupled to the pressing head; and
a controller electrically connected to the pressing module and the at least one securing module;
wherein in response to that the controller drives the compressive force generator to move the at least one securing module toward the battery tray rack through the pressing head and to compress the battery tray rack, the controller controls the locking device to lock the battery tray rack to form a containment on the battery tray rack or to unlock the battery tray rack to release the containment.

2. The containment apparatus for battery tray rack according to claim 1, wherein the at least one securing module further comprises a guiding post and a compression spring, and the slidable stage has a through hole; the guiding post passes through the through hole, and one of two ends of the guiding post is connected to the pressing head; the compression spring is fitted over the guiding post, and two ends of the compression spring respectively abut against the through hole and the other end of the guiding post.

3. The containment apparatus for battery tray rack according to claim 1, wherein the locking device comprises an electric motor, a socket adapter, a socket, and a spring; the socket has a bolt-fitting hole and an adapter-fitting hole; the bolt-fitting hole is adapted to lock or unlock the battery tray rack; the adapter-fitting hole is adapted to be fitted over the socket adapter, and a radial tolerance is between the adapter-fitting hole and the socket adapter; the socket adapter is connected to the electric motor; one of two ends of the spring abuts against the electric motor, and the other end of the spring abuts against the socket.

4. The containment apparatus for battery tray rack according to claim 3, wherein the locking device further comprises a cone-shaped washer and a fixation screw; the bolt-fitting hole of the socket has a cone-shaped bottom surface; the cone-shaped washer is accommodated in the bolt-fitting hole and abuts against the cone-shaped bottom surface; the fixation screw passes through the bolt-fitting hole and the cone-shaped washer and is secured to the socket adapter.

5. The containment apparatus for battery tray rack according to claim 1, further comprising a first position sensor, a second position sensor, a third position sensor, a reflection sensor, and a pressure sensor, wherein the first position sensor, the second position sensor, the third position sensor, the reflection sensor, and the pressure sensor are electrically connected to the controller; the first position sensor, the second position sensor, and the third position sensor are disposed on the base, a position of the first position sensor corresponds to an initial position of a stroke of the pressing head, and a position of the second position sensor and a position of the third position sensor respectively correspond to two maximum positions of the stroke of the pressing head; the reflection sensor is disposed on the pressing head and configured to detect a distance between the pressing head and the battery tray rack; the pressure sensor is disposed on the frame and configured to detect a compressive force applied to the battery tray rack by the compressive force generator.

6. The containment apparatus for battery tray rack according to claim 1, wherein the pressing head further comprises at least one magnet; in response to that the controller controls the locking device to unlock the battery tray rack to release the containment, the controller drives the compressive force generator to move the pressing head away from the battery tray rack and to stretch the battery tray rack through the at least one magnet.

7. A containment apparatus for battery tray rack, wherein the containment apparatus is adapted to apply a compressive force to a battery tray rack and to form a containment on the battery tray rack or to release the containment on the battery tray rack to cancel the compressive force; the battery tray rack comprises a force-bearing plate and at least one clamping bolt; the containment apparatus comprises:
a pressing module corresponding to the force-bearing plate of the battery tray rack;
at least one securing module corresponding to the at least one clamping bolt of the battery tray rack; and
a controller electrically connected to the pressing module and the at least one securing module;
wherein in response to that the containment apparatus is to contain the battery tray rack, the controller controls the pressing module to apply the compressive force to the force-bearing plate, so that the battery tray rack withstands a clamping pressure, and the controller controls the at least one securing module to lock the at least one clamping bolt to maintain the clamping pressure; in response to that the containment apparatus is to release the battery tray rack from the containment, the controller controls the pressing module to apply the compressive force to the force-bearing plate, and in response to that the controller controls the at least one securing module to unlock the at least one clamping bolt, the controller controls the pressing module to cancel the compressive force applied to the force-bearing plate.

8. The containment apparatus for battery tray rack according to claim 7, further comprising a frame, wherein the frame comprises a base; the pressing module comprises a compressive force generator and a pressing head, the pressing head is connected to the compressive force generator, and the compressive force generator is arranged on the frame and is adapted to drive the pressing head to move toward or away from the battery tray rack; the at least one securing module comprises a slidable stage and a locking device, and the locking device is arranged on the slidable stage and coupled to the pressing head; the controller drives the compressive force generator to move the at least one securing module toward the battery tray rack through the pressing head to apply the compressive force to the force-bearing plate, and the controller controls the locking device to lock the at least one clamping bolt to form the containment or to unlock the at least one clamping bolt to release the containment.

9. The containment apparatus for battery tray rack according to claim 8, wherein the at least one securing module further comprises a guiding post and a compression spring, and the slidable stage has a through hole; the guiding post passes through the through hole, and one of two ends of the guiding post is connected to the pressing head; the compression spring is fitted over the guiding post, and two ends of the compression spring respectively abut against the through hole and the other end of the guiding post; the controller drives the compressive force generator, so that the compressive force generator drives the pressing head to move the slidable stage toward the battery tray rack through the guiding post and the compression spring; in response to that the controller drives the compressive force generator to move the pressing head away from the battery tray rack, the pressing head directly pushes the slidable stage.

10. The containment apparatus for battery tray rack according to claim 8, wherein the pressing head further comprises at least one magnet; in response to that the containment apparatus is to release the containment on the battery tray rack, after the controller controls the locking device to unlock the at least one clamping bolt, the controller drives the compressive force generator to move the pressing head away from the battery tray rack and to stretch the battery tray rack by magnetically attaching the at least one magnet to the force-bearing plate.
